(19) United States
(12) Patent Application Publication
(10) Pub. No.: US 2026/0340003 A1
(43) Pub. Date: Oct. 29, 2026

(54) INFORMATION ANALYSIS METHOD, INFORMATION ANALYSIS SERVER, AND DIGITAL INFORMATION MANAGEMENT SYSTEM

(71) Applicant: Hitachi, Ltd., Tokyo (JP)

(72) Inventors: Hiroki YAMAMOTO, Tokyo (JP); Koji AMANO, Tokyo (JP); Makoto ONODERA, Tokyo (JP); Hiroshi YAMADA, Tokyo (JP)

(21) Appl. No.: 19/110,920

(22) PCT Filed: Sep. 25, 2023
(86) PCT No.: PCT/JP2023/034694

§ 371 Date: Mar. 12, 2025

(30) Foreign Application Priority Data
Oct. 26, 2022 (JP) 2022-171341

(51) Int. Cl. G06F 16/334

(52) U.S. Cl. CPC G06F 16/334

(57) ABSTRACT

Provided is an information analysis method for an information analysis server including a processor and a memory to analyze files used in a work terminal connected via a network. The information analysis method includes a first step, in which the information analysis server acquires files used in a plurality of phases of a work by phase and records the files to phase document information in association with locations of the files and the phases, a second step, in which the information analysis server analyzes words included in each file and determines a file similar in words to be a relevant file to provide a relational link, and a third step, in which the information analysis server records files used in each phase, locations of the files, and relational links provided to the files to meta-information.

### CLAIM OF PRIORITY

The present application claims priority from Japanese Patent Application No. 2022-171341 filed on Oct. 26, 2022, the content of which is hereby incorporated by reference into this application.

### TECHNICAL FIELD

This invention relates to a computer system for supporting improvement in work efficiency.

### BACKGROUND ART

To improve work efficiency, there are known techniques that automatically construct a workflow. For example, JP 2010-20634 A describes a technique that detects an irrelevant event that occurs irrelevant to business events and removes it from a workflow in collecting business events to automatically construct a workflow.

Meanwhile, a technique called text mining is known to analyze data used in a work. For example, JP 2006-244298 describes classifying words or attribute values extracted from a text to be analyzed into two or more classes to display them in a list, and in response to a user's designation of a word or attribute value, narrowing the extracted words or attribute values in association with the designated word or attribute value to display the result in a list.

### SUMMARY OF INVENTION

### Technical Problem

In pursuing a work, a person engaged in the work may experience a difficulty in finding appropriate material such as files, information, and drawings because a large volume of such material is scattered in various folders and systems. Even worse, if the person cannot find it, the material will not be used although it actually exists.

Demanded is automatically organizing existing files and information and providing appropriate files or information with progress of the work.

This invention is accomplished in view of the above-described problem and aims to improve the efficiency in pursuing a work by presenting files to be used in each phase of the work or information such as documents and data attributed to a system to be used for the work.

### Solution to Problem

This invention is an information analysis method for an information analysis server including a processor and a memory to analyze files used in a work terminal connected via a network, the information analysis method including: a first step, in which the information analysis server acquires files used in a plurality of phases of a work by phase and records the files to phase document information in association with locations of the files and the phases; a second step, in which the information analysis server analyzes words included in each file and determines a file similar in words to be a relevant file to provide a relational link; and a third step, in which the information analysis server records files used in each phase, locations of the files, and relational links provided to the files to meta-information.

### Advantageous Effects of Invention

Accordingly, this invention enables providing information on files required in each phase of a work, so that the reduction in effort to find a file improves the work efficiency. Sharing this information within a department or among departments expedites information sharing about the work. Moreover, sharing the information leads to skill learning because ordinary workers can refer to the knowledge of an expert.

The details of at least one embodiment of the subject disclosed in this specification are provided in the accompanying drawings and the following description. Other features, fashions, and effects of the subject are clarified in the following description, drawings, and claims.

### BRIEF DESCRIPTION OF DRAWINGS

FIG. 1A illustrates Embodiment 1 of the invention, and is a block diagram of a digital information management system.

FIG. 1B illustrates Embodiment 1 of the invention, and is a block diagram of a work system.

FIG. 2 illustrates Embodiment 1 of the invention, and is a flowchart illustrating the outline of processing to be performed in the digital information management system.

FIG. 3 illustrates Embodiment 1 of the invention, and is a diagram illustrating an example of recording a workflow.

FIG. 4 illustrates Embodiment 1 of the invention, and is a diagram providing an example of a work phase document table.

FIG. 5 illustrates Embodiment 1 of the invention, and is a first part of a sequence diagram illustrating an example of processing performed in the digital information management system.

FIG. 6 illustrates Embodiment 1 of the invention, and is a middle part of the sequence diagram illustrating an example of processing performed in the digital information management system.

FIG. 7 illustrates Embodiment 1 of the invention, and is a last part of the sequence diagram illustrating an example of processing performed in the digital information management system.

FIG. 8 illustrates Embodiment 1 of the invention, and is a diagram providing an example of a frequent word list.

FIG. 9 illustrates Embodiment 1 of the invention, and is a diagram providing an example of a file relationship table.

FIG. 10 illustrates Embodiment 1 of the invention, and is a diagram providing an example of a meta-information table.

FIG. 11 illustrates Embodiment 1 of the invention, and is a diagram illustrating a relationship among meta-information of a work, phases, and files.

FIG. 12 illustrates Embodiment 1 of the invention, and is a diagram illustrating examples of meta-information.

FIG. 13 illustrates Embodiment 1 of the invention, and is a diagram illustrating an example of a screen for supporting a workflow.

FIG. 14 illustrates Embodiment 2 of the invention, and is a diagram illustrating an example of a screen for supporting a workflow with frequent word lists and word correlation charts.

### DESCRIPTION OF EMBODIMENTS

Hereinafter, embodiments of this invention will be described based on the accompanying drawings.

### Embodiment 1

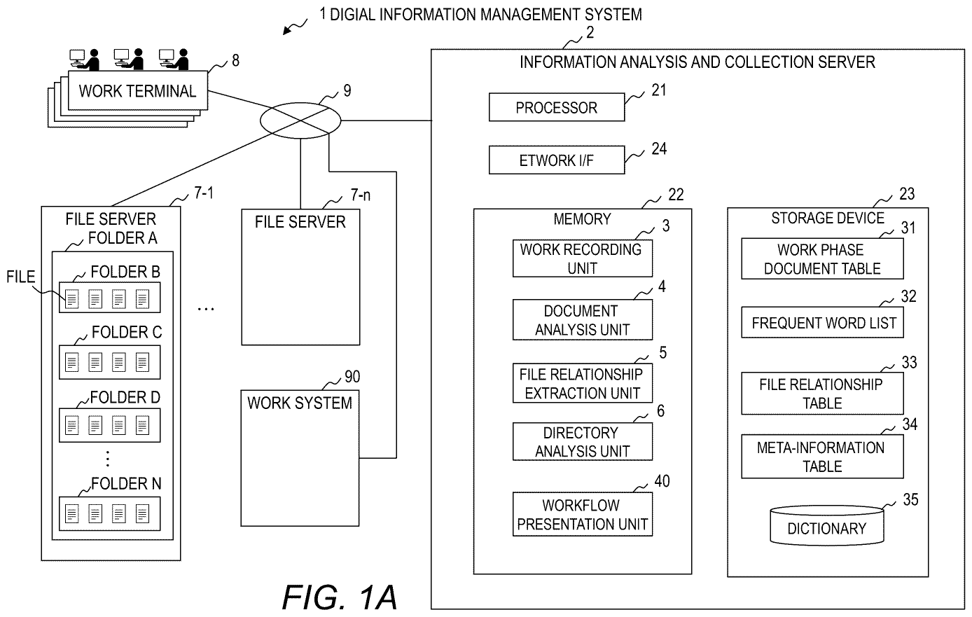

FIG. 1A illustrates Embodiment 1 of the invention, and is a block diagram of a digital information management system 1. The digital information management system 1 in this embodiment manages a work by phase. It records the specifics of the work processing performed in a work terminal 8 by phase, analyzes the files (data or documents) used in each phase and the locations of the files, and presents files required at each phase. In this embodiment, “files” include not only document files stored in folders but also historical information indicating the previous operation of manufacturing facilities, such as error lists, alarm lists, and trend graphs stored in their control apparatuses, and a variety of information stored in systems such as a facility management system and a production system.

### System Configuration

The digital information management system 1 includes work terminals 8 for performing works, file servers 7-1 to 7-n for storing files to be used in the works, a work system 90 to be used in the works, an information analysis and collection server 2 for analyzing information such as files and data used in each phase to generate meta-information and presenting data to be used in each phase with reference to the meta-information, and a network 9 connecting the apparatuses.

Unless a specific file server does not need to be referred to, a reference sign “7” without a suffix beginning with “-” is used. The same applies to the reference signs of the other elements. The apparatus for storing the files to be used in the works is not limited to the file server 7 but can be a storage device such as a network-attached storage (NAS). The files to be used in a work do not need to be in the folders under the same directory and can be scattered in various folders.

The information analysis and collection server 2 is a computer including a processor 21, a memory 22, a storage device 23, and a network interface 24. A work recording unit 3, a document analysis unit 4, a file relationship extraction unit 5, a directory analysis unit 6, and a workflow presentation unit 40 are loaded to the memory 22 as programs and they are executed by the processor 21.

The processor 21 performs processing in accordance with the programs of function units to work as the function units for providing predetermined functions. For example, the processor 21 performs processing in accordance with the document analysis program to function as the document analysis unit 4. The same applies to the other programs. Furthermore, the processor 21 works as function units for providing functions of a plurality of processes executed by a program. A computer and a computer system are an apparatus and a system including these function units.

The work recording unit 3 acquires specifics of each work performed in the work terminals 8 and files used in each phase of the work and records them in a work phase document table 31. The work recording unit acquires phases of a work and records the files used at the work terminals 8 by phase. The “files” can include data and documents used by the work terminals 8, and tables and URLs accessed by the work terminals 8. The details of the work phase document table 31 will be described later. In the work phase document table 31, a person (operator) to be engaged in the work can determine and register the name of the work to be recorded in advance.

The work recording unit 3 also extracts meta-information from the works, phases, and files based on the output of the document analysis unit 4 and stores the meta-information to a meta-information table 34.

The document analysis unit 4 extracts words from the files and systems used in each phase, calculates the appearance frequencies of the words, and generate a frequent word list 32. The document analysis unit 4 can use a generally or publicly known technique such as morphological analysis.

The file relationship extraction unit 5 extracts files relevant to the files used in each phase and generates a file relationship table 33.

The directory analysis unit 6 analyzes the locations of the files used in a work and records the locations to the work phase document table 31. The location of a file can be expressed by a file path, for example.

The workflow presentation unit 40 extracts a workflow from the work phase document table 31 and the meta-information table 34 and outputs files to be used in each phase of a work and their relevant files to support the operator of a work terminal 8 in pursuing the work.

The storage device 23 stores the work phase document table 31, the frequent word list 32, the file relationship table 33, the meta-information table 34, and a dictionary 35. The details of the information will be described later.

The file servers 7 are computers for providing files to the work terminals 8. The file servers 7 in this embodiment store the files in a directory structure; FIG. 1 provides an example where a folder A has a plurality of subfolders B to N and files are stored in the subfolders B to N.

This embodiment provides an example where a work terminal 8 performs a work with reference to a file in a file server 7 and using data in the work system 90. FIG. 1B is a diagram illustrating an example of the work system 90. The work system 90 includes one or more work systems such as a work system #1 (910-1) and a work system #2 (910-2).

The work system #1 (910-1) provides a database #1 (920-1) and a list #1 (930-1); the work system #2 (910-2) provides a database #2 (920-2) and a list #2 (930-2).

### Data

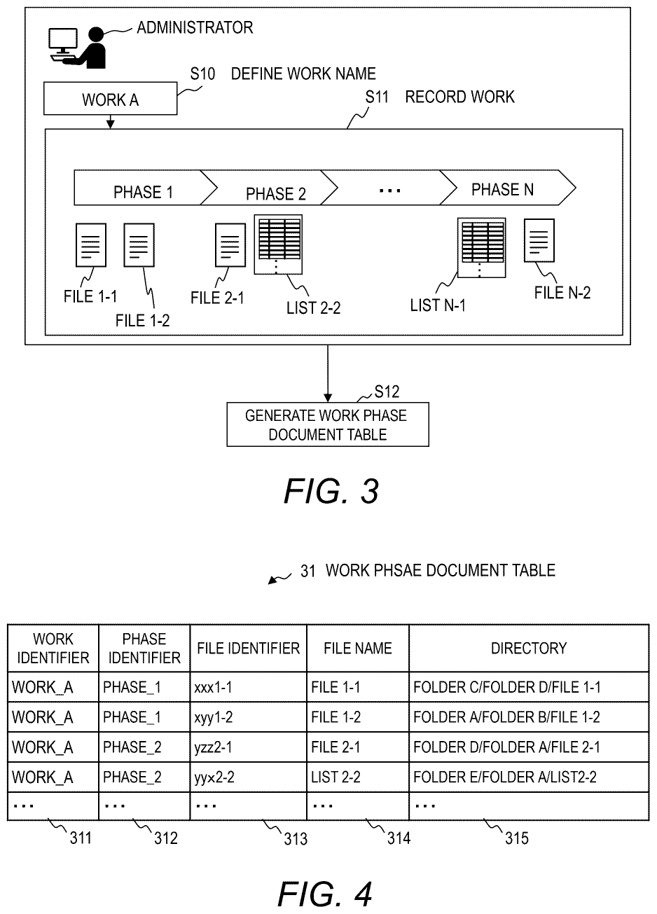

The files to be used by the information analysis and collection server 2 are described. FIG. 4 is a diagram providing an example of the work phase document table 31. The work phase document table 31 is generated by the work recording unit 3 and the directory analysis unit 6.

The work phase document table 31 includes a work identifier 311, a phase identifier 312, a file identifier 313, a file name 314, and a directory 315 in one entry.

The work identifier 311 stores an identifier for identifying a work. In this embodiment, the work recording unit 3 assigns the work identifier 311. The phase identifier 312 stores an identifier for identifying a phase. In this embodiment, the work recording unit 3 assigns the phase identifier 312.

The file identifier 313 stores an identifier of a file assigned by the directory analysis unit 6. The file identifier 313 is a value unique in the digital information management system 1 to distinguish files having the identical file names stored in different file servers 7 or different folders. The file identifier 313 can be composed of identifiers for specifying a file or data; for example, it can be an identifier structured by delimiting multiple identifiers sorted from the one at a broad viewpoint to the one at a narrow viewpoint with slashes, like tool name/company name/plant name/work name/phase name/file name.

The file name 314 stores a name assigned to the file. The directory 315 stores the location of the file such as a combination of a file server and a folder where the file is stored or a URL.

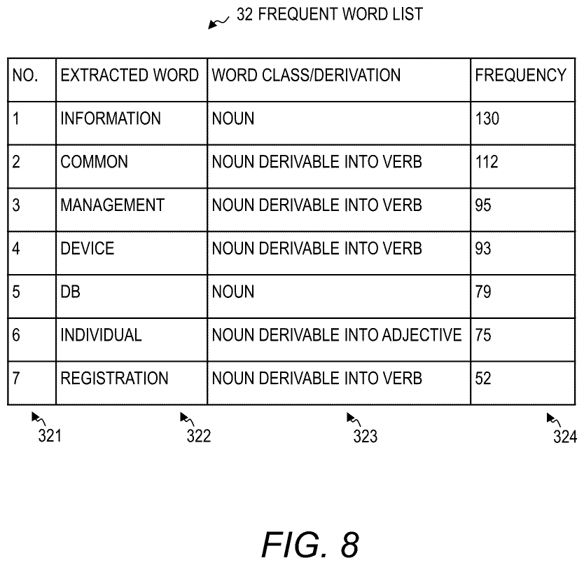

FIG. 8 is a diagram providing an example of the frequent word list 32. The frequent word list 32 is generated by the document analysis unit 4 for each file. The frequent word list 32 includes a rank 321, an extracted word 322, a word class/derivation 323, and a frequency 324 in one entry.

The rank 321 stores a rank in the appearance frequency. The extracted word 322 stores a word extracted from the file by the document analysis unit 4. The word class/derivation 323 stores a word class or a manner of derivation. The frequency 324 stores the appearance frequency in the file of the extracted word.

The frequent word list 32 can present words characterizing the analyzed file by sorting the words by appearance frequency. This embodiment compares the file relationships using high-ranked (for example, top 30) words in the appearance frequency.

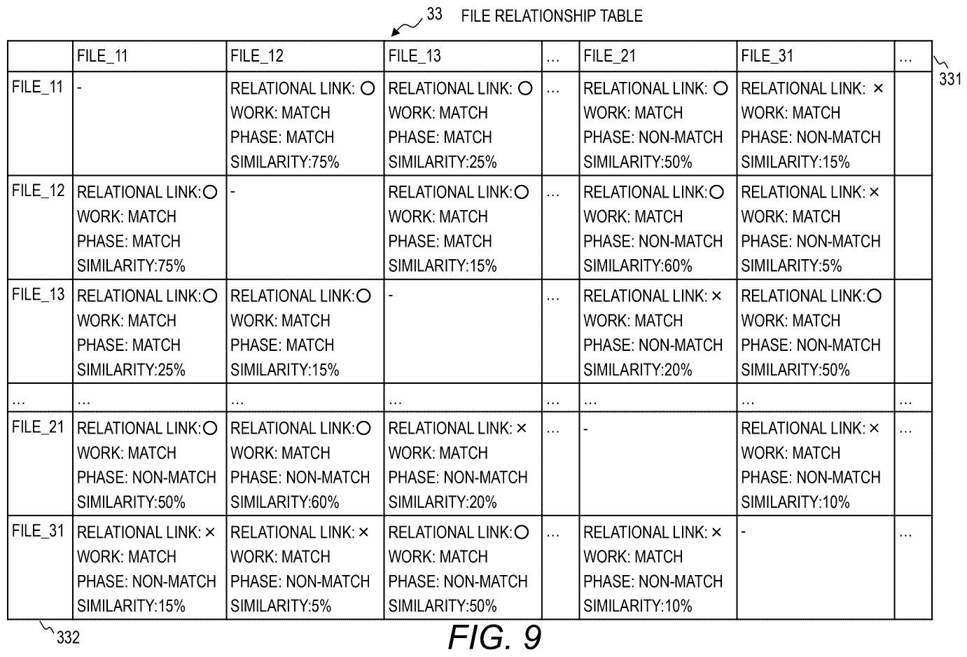

FIG. 9 is a diagram providing an example of the file relationship table 33. The file relationship table 33 is generated by the file relationship extraction unit 5 with respect to each file. The file relationship table 33 stores relationships between two files identified by the file identifiers aligned in a column 331 and the file identifiers aligned in a row 332.

The relationship between two files includes a relational link, a degree of sameness in work, a degree of sameness in phase, and a similarity between files. The relational link is determined in accordance with rules defined with the degree of sameness in work, the degree of sameness in phase, and the similarity between files. If two files are relevant, the relational link is assigned a circle mark and if they are irrelevant, the relational link is assigned a cross mark.

The degree of sameness in work is assigned “match” when the two files are used in the same work and otherwise, “non-match”. A degree of sameness in phase is assigned “match” when the two files are used in the same phase and otherwise, “non-match”.

The similarity between files in this embodiment is expressed by the degree (rate) of match of predetermined high-ranked (for example, top 30) words in appearance frequency in the two files. In addition to the degree of match of such words, the semantic similarity between words can be taken account to calculate the similarities of the words in the two files. The similarity between words can be calculated by software such as Word2Vec.

An example of determination about a relational link by the file relationship extraction unit 5 determines that the two files are relevant if predetermined conditions are satisfied. For example, the files are determined to be relevant if the works of the two files are “match” and the similarity between the files is higher than a predetermined first threshold value Th1 (14%). The files are also determined to be relevant if the similarity between the files is higher than a predetermined second threshold value Th2 (49%), even if the phases of the two files are “non-match”. Note that the two threshold values have a relation of the first threshold value Th1<the second threshold value Th2.

According to this policy, a relational link is provided between the files as far as the degree of match of the high-ranked words in appearance frequency is higher than the second threshold value Th2 even if the files are used in different phases; as a result, usable files can be automatically extracted regardless of the phase.

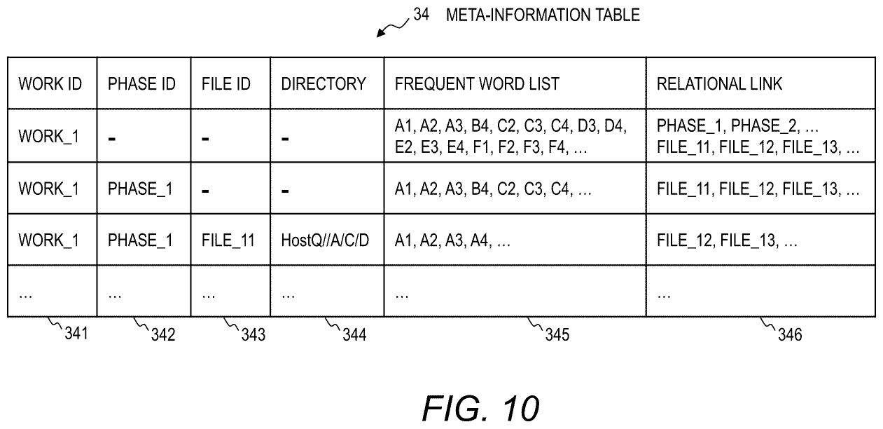

FIG. 10 is a diagram providing an example of the meta-information table 34. The meta-information table 34 includes a work ID 341, a phase ID 342, a file ID 343, a directory 344, a frequent word list 345, and a relational link 346 in one entry.

The work ID 341 stores an identifier for identifying a work. The work ID 341 corresponds to the work identifier 311 in the work phase document table 31. The phase ID 342 stores an identifier for identifying a phase. The phase ID 342 corresponds to the phase identifier 312 in the work phase document table 31. The work identifier 341 and the phase identifier 342 can be expressed together with a slash, like WORK_1/PHASE_1.

The file ID 343 stores an identifier for identifying a file. The file ID 343 corresponds to the file identifier 313 in the work phase document table 31. The directory 344 stores the location of the file. The directory 344 corresponds to the directory 315 in the work phase document table 31.

The frequent word list 345 stores predetermined high-ranked (e.g., top 30) extracted words 322 in the frequent word list 32 generated specific to the file. The relational link 346 stores files, phases, and works paired by being provided with a relational link in the file relationship table 33.

The meta-information table 34 can store meta-information of works, meta-information of phases, and meta-information of files. In the entry of “WORK_A” in the first row, the phase ID 342 and the file ID 343 are blank and therefore, this entry provides meta-information of “WORK_A”. The meta-information of a work consists of a frequent word list 345 and a relational link 346.

In the entry of “PHASE_1” in the second row, the file ID 343 is blank and the work ID 341 is “WORK_A” and therefore, this entry provides meta-information of “PHASE 1”. The meta-information of a phase consists of a work ID 341, a frequent word list 345, and a relational link 346.

In the entry of “FILE_11” in the third row, the work ID 341, the phase ID 342, and the file ID 343 include values and therefore, this entry provides meta-information of “FILE_11”. The meta-information of a file consists of a work ID 341, a phase ID 342, a file ID 343, a directory 344, a frequent word list 345, and a relational link 346. Since a file can be commonly used in different phases or different works, the work ID 341 and the phase ID 342 can include a plurality of identifiers.

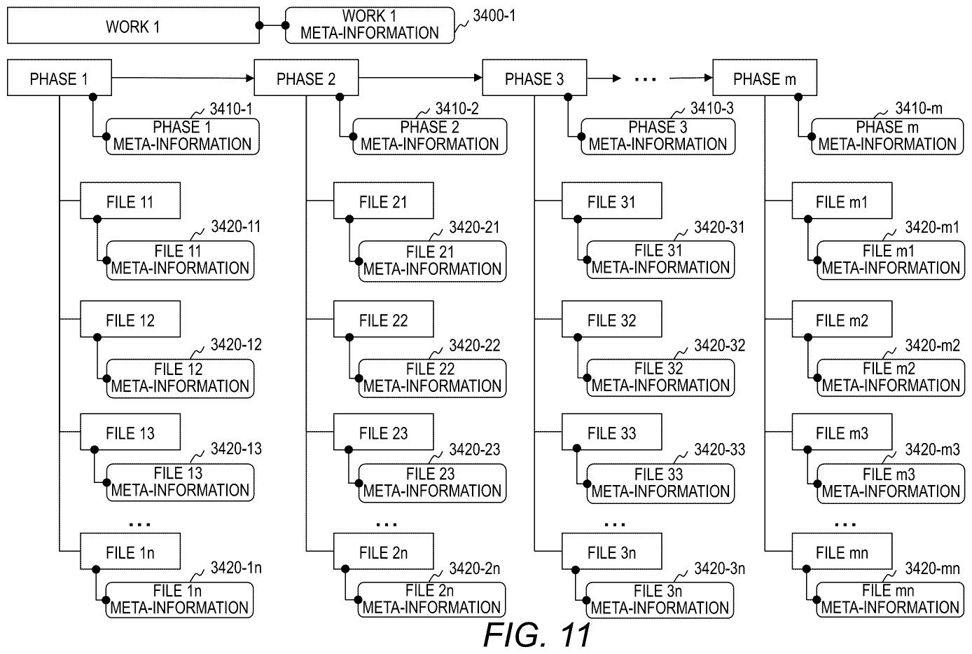

FIG. 11 is a diagram illustrating a relationship among meta-information of a work, phases, and files. FIG. 11 illustrates the relationship among work-level Work 1 meta-information 3400-1, phase-level Phase 1 meta-information 3410-1 to Phase m meta-information 3410-m, file-level File 11 meta-information 3420-11 to File mn meta-information 3420-nm.

The Phase 1 meta-information 3410-1 of the phase 1 is information obtained by aggregating (or combining) File 11 meta-information 3420-11 to File in meta-information 3420-1n of the files 11 to 1n used in the phase 1. The same applies to Phase 2 meta-information 3410-2 to Phase m meta-information 3410-m. The Work 1 meta-information 3400-1 is information obtained by aggregating (or combining) Phase 1 meta-information 3410-1 to Phase m meta-information 3410-m.

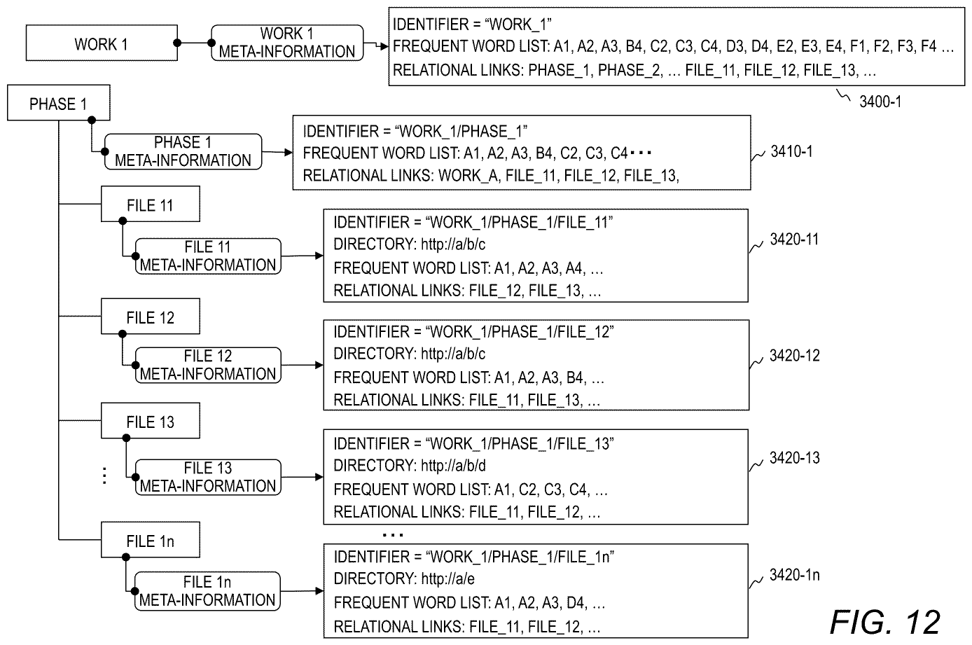

FIG. 12 is a diagram providing specifics of the meta-information of a work, a phase, and files. FIG. 12 provides specifics of the Work 1 meta-information 3400-1, Phase 1 meta-information 3410-1, and File 11 meta-information 3420-11 to File 1n meta-information 3420-1n.

### Outline of Processing

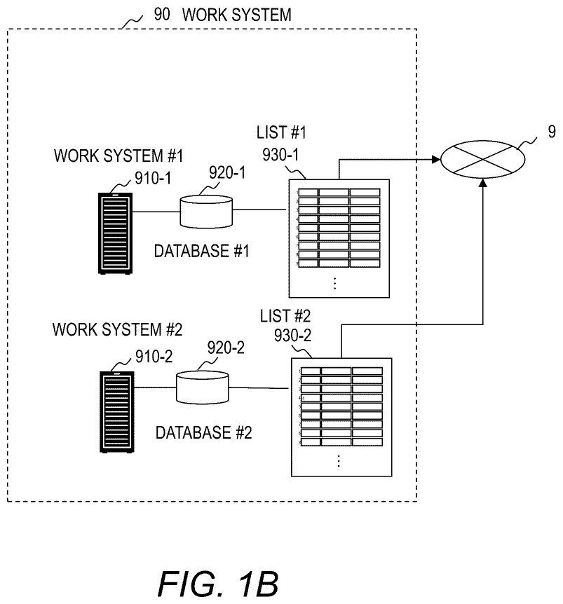

FIG. 2 is a flowchart illustrating the outline of processing to be performed in the digital information management system 1. This processing is executed at a predetermined time such as when a work is added or amended, or periodical times. First, in response to an instruction from an administrator operating a work terminal 8 to start recording workflows, the work recording unit 3 in the information analysis and collection server 2 monitors the processing performed in the work terminals 8 to record the files used in the processing to the work phase document table 31 by phase of each work (S1).

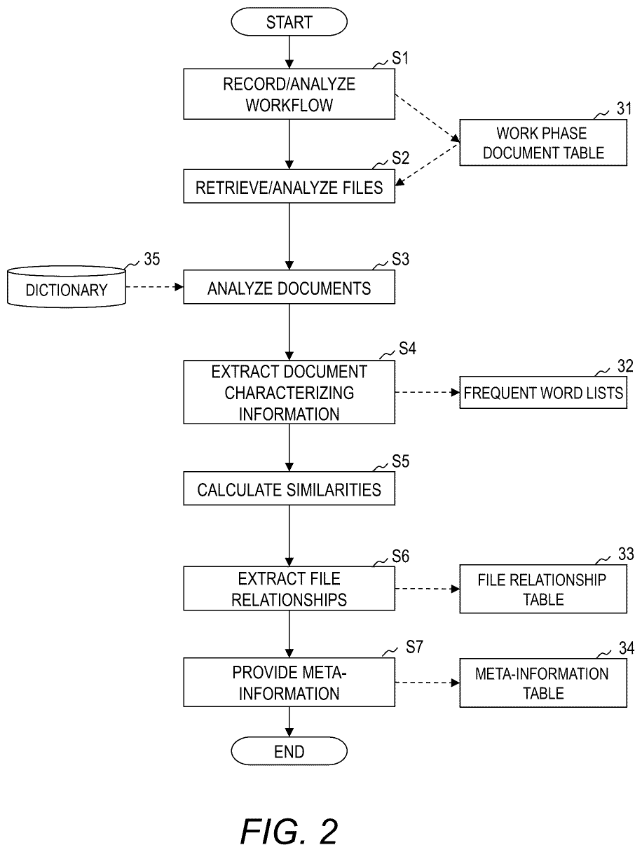

The names or identifiers of works can be provided in advance by the administrator to the information analysis and collection server 2 through a work terminal 8 (S10) as illustrated in FIG. 3. The names or identifiers of phases of each work can also be provided in advance by the administrator to the information analysis and collection server 2 through a work terminal 8.

Operators who perform works access files through work terminals 8 with designation of a phase; the work recording unit 3 acquires file names 314 and directories 315 used in the work terminals 8 (S11 in FIG. 3) and records them to the work phase document table 31 by phase of the work (S12 in FIG. 3). Identifying the work and phase and recording a file to the work phase document table 31 can be automated by using an automatic workflow generation tool such as the one in the aforementioned related art.

When the operators finish their works, the administrator operating a work terminal 8 issues an instruction to terminate the recording of workflows. The work recording unit 3 of the information analysis and collection server 2 instructs the directory analysis unit 6 to retrieve files for a work to be analyzed. The directory analysis unit 6 retrieves files for the designated work by phase with reference to the phase identifiers 312 in the work phase document table 31 (S2).

When the directory analysis unit 6 finishes retrieving files, the document analysis unit 4 in the information analysis and collection server 2 analyzes each file with the dictionary 35 and extracts words (S3). Next, the document analysis unit 4 calculates the appearance frequency of each extracted word and generates a frequent word list 32 for each file (S4).

The document analysis unit 4 compares the frequent word lists 32 of the files used in each phase of the work to be analyzed and calculates the similarities between files (S5). The document analysis unit 4 further determines whether to provide a relational link to each pair of files based on the degrees of sameness in work and phase and the similarity between the files and generates a file relationship table 33 (S6).

When generating the file relationship table 33 is finished, the work recording unit 3 generates meta-information table 34 from the work phase document table 31 as a workflow, the frequent word lists 32, and the file relationship table 33 (S7).

The work phase document table 31 and the meta-information table 34 generated in the foregoing processing enable the information analysis and collection server 2 to present files to be used in each phase of a work and the locations of the files to the operator pursuing the work with a work terminal 8.

Furthermore, the meta-information table 34 enables presenting files having relevancy as relational links for each phase. A file provided with a relational link can be automatically presented as a useful file, as far as the similarity of the file based on the appearance frequencies of words is higher than the second threshold value Th2 even if the file is not used in the same phase in the work phase document table 31.

As described above, the information analysis and collection server 2 automatically provides files to be used and useful files for each phase by presenting a workflow with the meta-information table 34 incorporated. Hence, the work efficiency is improved.

### Details of Processing

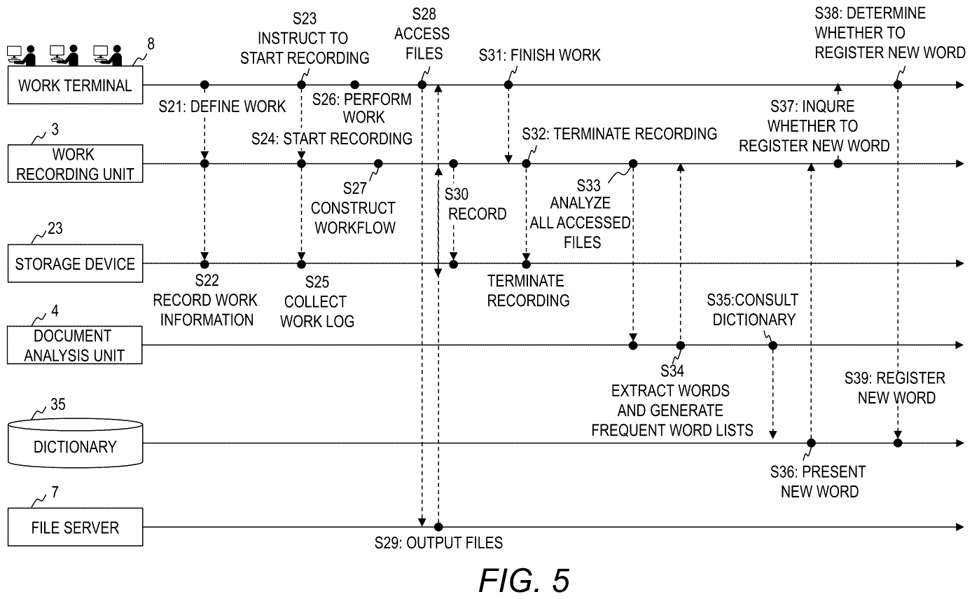

FIGS. 5 to 7 is a flowchart illustrating details of the processing performed in the digital information management system 1. This processing is started based on an instruction of the administrator of the digital information management system 1. The administrator operating a work terminal 8 instructs the work recording unit 3 of the information analysis and collection server 2 of the names or identifiers of works and the definitions of the works each composed of the names or identifiers of phases (S21). The work recording unit 3 records the definitions of the works received from the work terminal 8 to the work phase document table 31 in the storage device 23 as work information (S22).

Next, the administrator instructs the work recording unit 3 to start recording the works through the work terminal 8 (S23). The work recording unit 3 records the specifics of the processing (S26) performed in the work terminals 8 operated by operators (S24) and records information on the files used in each phase to the work phase document table 31 in the storage device 23 (S25). The work recording unit 3 can store the logs of the processing of the work terminals 8 to the storage device 23.

The work recording unit 3 constructs workflows by recording the files used in each phase to the work phase document table 31 (S27). When a file server 7 receives an access request from a work terminal 8 (S28), it outputs a designated file (S29). The work recording unit 3 monitors the processing of the work terminals 8 and records the file names and the directories designated by access requests to the work phase document table 31 (S30).

When the works at the work terminals 8 are finished (S31), the work recording unit 3 terminates recording the processing of the work terminals 8 (S32). When the works are finished, the administrator may explicitly instruct the work recording unit 3 to terminate the recording as described above.

The work recording unit 3 retrieves the files used in a work to be analyzed with the directory analysis unit 6 and instructs the document analysis unit 4 to analyze the documents of the retrieved files (S33). The document analysis unit 4 analyzes each file with the dictionary 35 to extract words and calculates the appearance frequency in the file of each extracted word to generate a frequent word list 32 for the file (S34).

Next, the document analysis unit 4 consults the dictionary with each word (S35) and if the extracted words include a word not contained in the dictionary 35, it outputs the word to the word recording unit 3 as a new word (S36). In response to the output of a new word, the work recording unit 3 makes an inquiry to a work terminal 8 whether to register the new word to the dictionary 35 (S37).

The administrator at the work terminal 8 determines whether to register the new word (S38) and instructs the work recording unit 3 whether to register the new word to the dictionary 35 (S39).

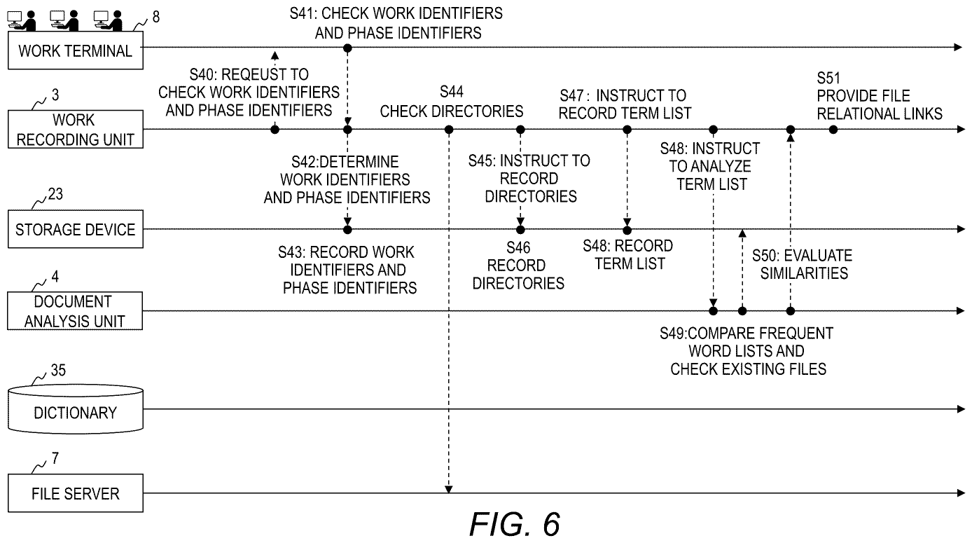

Next, at Step S40 in FIG. 6, the work recording unit 3 makes an inquiry to a work terminal 8 whether the work identifiers 311 and phase identifiers 312 in the generated work phase document table 31 are appropriate. The administrator at the work terminal 8 reviews the work phase document table 31 to determine whether they are appropriate, and if appropriate, approves the work identifiers 311 and phase identifiers 312 (S41, S42) and records them to the work phase document table 31 in the storage device 23 (S43). If not appropriate, the administrator records the amended ones to the work phase document table 31.

The work recording unit 3 makes inquiries to the file servers 7 whether the file names 314 and the directories 315 in the work phase document table 31 are correct, using the directory analysis unit 6 (S44). The work recording unit 3 records the results of the inquiries to the work phase document table 31 in the storage device 23 (S45, S46).

Next, the work recording unit 3 collects the work identifiers 311 and phase identifiers 312 from the work phase document table 31 to generate a term list (not shown) and stores it to the storage device 23 on a temporary basis (S47, S48).

The work recording unit 3 makes the document analysis unit 4 analyze the generated term list (S48) and extract identifiers to compare the relationships between files in the work phase document table 31. Next, the document analysis unit 4 retrieves the extracted identifiers and the frequent word lists 32 to evaluate the relationships between files in the work phase document table 31 (S49). The document analysis unit 4 calculates similarity of each combination of files based on the degree of sameness in work, the degree of sameness in phase, and the degree of sameness in frequent word list 32 to determine whether to provide a relational link to each file pair (S50).

The document analysis unit 4 notifies the work recording unit 3 of the evaluation results; the work recording unit 3 instructs the file relationship extraction unit 5 to generate a file relationship table 33 based on the evaluation results (S51). The file relationship extraction unit 5 acquires the evaluation results from the document analysis unit 4 to generate a file relationship table 33.

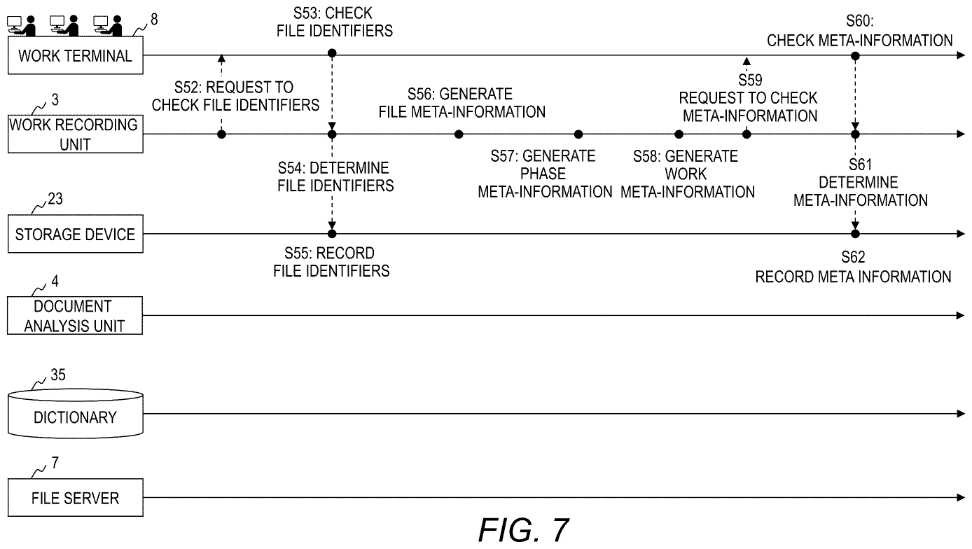

Next, at Step S52 in FIG. 7, the work recording unit 3 makes the directory analysis unit 6 generate file identifiers 313 and makes an inquiry to a work terminal 8 whether the file identifiers 313 of the files are appropriate. The administrator reviews the file names 314, directories 315, and file identifiers 313 in the work phase document table 31 to determine whether the work identifiers 313 are assigned appropriately (S53).

If the file identifiers 313 are appropriate, the administrator issues an instruction to fix the file identifiers 313 through the work terminal 8 (S54); the work recording unit 3 records the file identifiers 313 to the work phase document table 31 (S55). If one or more of the file identifiers 313 are not appropriate, the administrator records amended ones to the work phase document table 31.

The work recording unit 3 retrieves the work identifiers 311, the phase identifiers 312, the file identifiers 313, the frequent word lists 32, and the directories 315, generates file-level meta-information as illustrated in FIG. 12, and records it to the meta-information table 34 (S56).

The work recording unit 3 retrieves the work identifiers 311, the phase identifiers 312, and the file-level meta-information of the files in the same phase, aggregates (or combine) the file-level meta-information to generate phase-level meta-information as illustrated in FIG. 12, and records it to the meta-information table 34 (S57).

The work recording unit 3 retrieves the work identifiers 311 and the phase-level meta-information of the phases of the same work, aggregates the phase-level meta-information to generate work-level meta-information as illustrated in FIG. 12, and records it to the meta-information table 34 (S58).

The work recording unit 3 presents the generated meta-information table 34 to a work terminal 8 and requests the administrator to determine whether the meta-information table 34 is appropriate (S59). The administrator at the work terminal 8 determines whether the meta-information table 34 is appropriate (S60). If the meta-information table 34 is appropriate, the administrator sends an instruction to register (or fix) the meta-information table 34 through the work terminal 8 (S61). The work recording unit 3 records the meta-information table 34 to the storage device 34 based on the instruction from the work terminal 8. If the meta-information table 34 is not appropriate, the administrator records amendments to the meta-information table 34.

Through the foregoing processing, a work phase document table 31, frequent word lists 32, a file relationship table 33, and a meta-information table 34 are generated, so that the information analysis and collection server 2 can present files to be used in each phase of a work and files relevant to each phase to an operator performing the work with a work terminal 8.

### Work Support

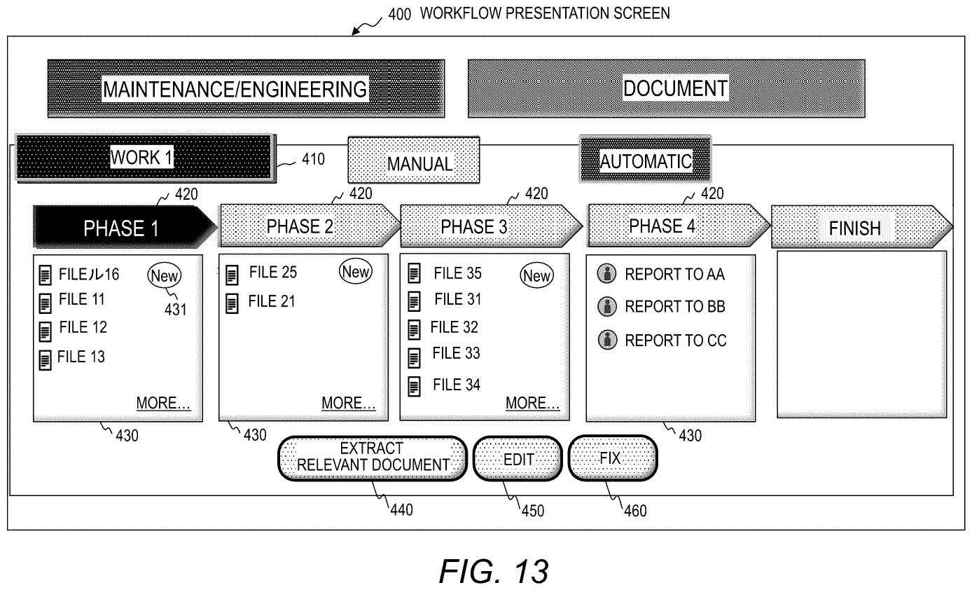

FIG. 13 is a diagram illustrating an example of a screen for supporting a workflow. The workflow presentation unit 40 in the information analysis and collection server 2 outputs the workflow presentation screen 400 in FIG. 12 to the work terminals 8 in order to support the work to be performed at the work terminals 8, using the work phase document table 31 and the meta-information table 34 generated in the above-described processing.

The workflow presentation screen 400 displayed on the display (not shown) of each work terminal 8 includes a work display area 410 for displaying the name of the selected work, phase display areas 420 for displaying the names of defined phases, file display areas 430 for presenting the files to be able to be used in the phases, an “Extract relevant document” button 440 to extract files having a relational link, an “Edit” button 450 to edit the files to be presented, and a “Fix” button 460 to fix the edited information.

The work display area 410 displays the name of the work selected in a not-shown selection screen. Each phase display area 420 displays the name of a phase of the work and the currently selected “Phase 1” is highlighted.

Each file display area 430 can display the file names 314 in the work phase document table 31 and the files in the relational links 346 in the meta-information table 34. The operator of the work terminal 8 can open a file by selecting and clicking its file name in a file display area 430.

When the operator clicks the “Extract relevant document” button 440, the relational links between the documents stored in the file servers 7 in the digital information management system 1 and the files specified in the work phase document table 31 to be used in the currently selected phase are recalculated and a file newly provided with a relational link is extracted.

In response to a click of the “Extract relevant document” button 440 at the work terminal 8, the information analysis and collection server 2 executes Steps S5 to S7 shown in FIG. 2, extracts a new file relevant to any of the files to be used in the currently selected phase, and displays an icon “New” 431 in the file display area 430. The newly extracted relational link is added to the file relationship table 33 and the meta-information table 34.

The information in the file display areas 430 becomes editable in response to a click of the “Edit” button 450 and the edited information is fixed in response to a click of the “Fix” button 460 and reflected to the work phase document table 31, the file relationship table 33, and the meta-information table 34.

Using the workflow presentation unit 40 of the information analysis and collection server 2, the operator of the work terminal 8 can accurately pursue the work by opening the files in the file display areas 430 in the workflow presentation screen 400 without being concerned about the locations of the required files in each phase.

As a result of reducing the effort to search for files, the work efficiency improves. Furthermore, the relational links of the files to be used in each phase can be updated as needed by operating the “Extract relevant document” button 440. The files relevant to the files for a phase can be extracted as needed from the files added to or updated in the file servers 7.

In this way, the information analysis and collection server 2 can speedily incorporate new files into a workflow, so that the work efficiency improves with freshness of the workflow.

Because of the above-described configuration, work-level, phase-level, and file-level meta-information are accumulated in the information analysis and collection server 2. As a result, when a person (operator) engaged in a work manually searches for desired information using a search function provided in the work terminal 8 during the work, the meta-information table 34 exhibits an effect to bring a search result outside the search scope. Like this example, the operator can artificially innovate the knowledge about the work.

### Embodiment 2

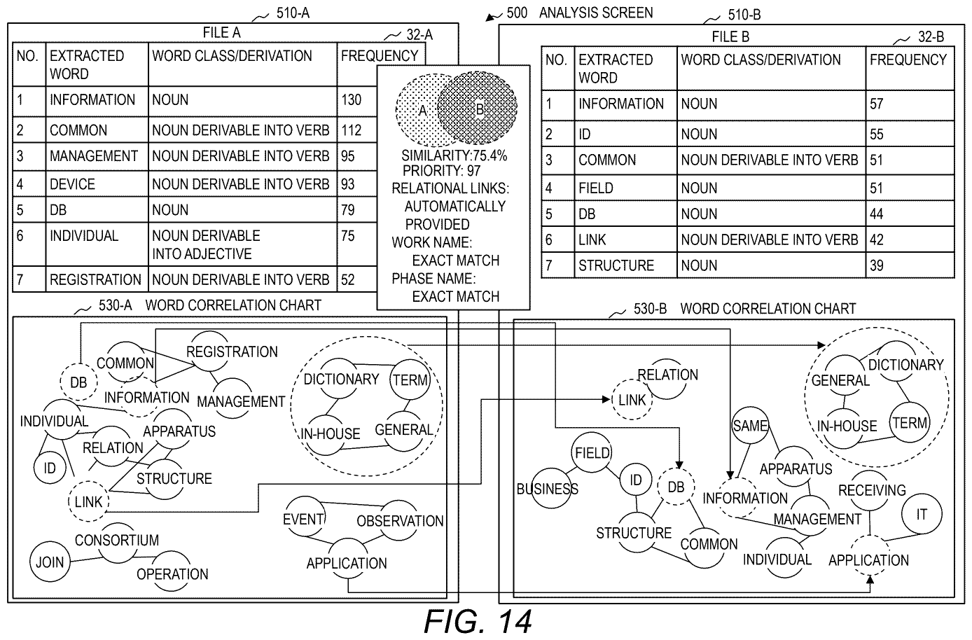

FIG. 14 illustrates the second embodiment where the file relationship extraction unit 5 generates an analysis screen 500 that visualizes the relationship between files and outputs it to a work terminal 8 in extracting file relationships at Step S6 in FIG. 2 in the foregoing Embodiment 1. The other configurations are the same as those in the foregoing Embodiment 1.

In this embodiment, the document analysis unit 4 generates a word correlation chart in addition to the frequent word list 32 for each file and the file relationship extraction unit 5 displays words relevant in the word correlation charts of two files being compared in the analysis screen 500.

The word correlation chart can be generated by a generally or publicly known technique; expressing neighboring words in the file to be compared as apexes and connecting them into a network to express the relationship of the words.

The analysis screen 500 includes areas for a file A analysis result 510-A and a file B analysis result 510-B to display the analysis results on two files of A and B and an area for displaying relational link information 520 on the two files.

The area for the file A analysis result 510-A includes an area for displaying the frequent word list 32-A of the file A and an area for displaying the word correlation chart 530-A of the file A. The area for the file B analysis result 510-B includes an area for displaying the frequent word list 32-B of the file B and an area for displaying the word correlation chart 530-B of the file B.

The relational link information 520 is displayed between the file A analysis result 510-A and the file B analysis result 510-B. The relational link information 520 indicates the similarity in words, the degree of sameness in work name, and the degree of sameness in phase name between the two files.

The analysis screen 500 visualizes the relationship of the words in two files determined to have relevancy by appearance frequencies and connections of the words. Then, the operator or the administrator using a work terminal 8 can know frequently appearing words and the gist of each file.

Furthermore, the operators' feedback indicating whether the relational links automatically constructed by the information analysis and collection server are “useful” or “not useful” can be recorded. This configuration enables important information for a work to be displayed preferentially. For example, an operator's feedback “useful” raises the score of the relational link to present the file preferentially. Conversely, an operator's feedback “not useful” lowers the score of the relational link to lower the degree of priority. Such “degree of priority” determined by the operators' feedback can be recorded in the meta-information table. The “degree of priority” is an indicator to determine whether to preferentially display a relational link or not and an example of it is a value increasing or decreasing depending on whether an operator's feedback is “useful” or “not useful”.

### Closing

As set forth in the foregoing Embodiments 1 and 2, the digital information management system 1 acquires files used in a plurality of phases of a work by phase, analyzes the words appearing in each file to automatically provide a relational link to files having high similarity as relevant files, and automatically stores relational links between files and the storage places (locations) of the files to meta-information table 34 in association with phases. Hence, the digital information management system 1 can provide information on the files required in each phase of a work and the files having a relational link with them, so that the reduction in effort to find a required file improves the work efficiency. The relational link enables providing latest files; a work can be performed with latest information. The latest file can be displayed preferentially. The digital information management system 1 not only reduces the time to find a file from scattered files but also supports in-house information sharing or skill learning.

The digital information management system 1 in the foregoing embodiments can be configured as follows.
(1) An information analysis server (the information analysis and collection server 2) including a processor (21) and a memory (22) performs an information analysis method to analyze files used in a work terminal (8) connected via a network (9). The information analysis method includes a first step, in which the information analysis server acquires files (314) used in a plurality of phases (phase identifiers 312) of a work (work identifier 311) by phase (312) and records the files (314) to phase document information (work phase document table 31) in association with locations (directories 315) of the files and the phases (312), a second step, in which the information analysis server (2) analyzes words included in each file (314) and determines a file similar in words to be a relevant file to provide a relational link, and a third step, in which the information analysis server (2) records files (314) used in each phase (312), locations (315) of the files, and relational links provided to the files to meta-information (meta-information table 34).

This configuration enables the information analysis and collection server 2 to provide information on the locations (directories 315) of the files required in each phase of a work and files having a relational link with the files. The operator of the work terminal 8 can reduce the effort to find a required file, so that the work efficiency improves.
(2) In the information analysis method according to the foregoing (1), the second step includes calculating appearance frequencies of the words by file, calculating rates of match of predetermined high-ranked words in appearance frequency between files as similarities, and determining that two files are relevant to provide a relational link in a case where a similarity of the two files is higher than a predetermined first threshold value (Th1).

With this configuration, the information analysis and collection server 2 compares high-ranked words in appearance frequency between files and provides a relational link if the degree of match of the words is higher than the first threshold value Th1. As a result, the information analysis and collection server 2 can automatically extract files usable in each phase.
(3) In the information analysis method according to the foregoing (2), the second step includes determining that two files (314) are relevant to provide a relational link as far as a similarity of the two files is higher than a predetermined second threshold value (Th2) that is higher than the first threshold value (Th1) even in a case where the two files are used in different phases (312).

With this configuration, the information analysis and collection server 2 provides a relational link as far as the degree of match of the high-ranked words in appearance frequency between files is higher than the second threshold value Th2, even if the files are used in different phases. As a result, the information analysis and collection server 2 can automatically extract usable files, regardless of the phase.
(4) In the information analysis method according to the foregoing (2), the meta-information in the third step includes file-level meta-information holding the relational links, the locations (315) of the files, and the appearance frequencies of words by file and phase-level meta-information holding the relational links, the locations of the files, and the appearance frequencies of words by phase.

This configuration enables the operator using the work terminal 8 to acquire files usable in a phase by referring to relational links in phase-level meta-information in the meta-information table 34 in the information analysis and collection server 2 and to acquire the locations of the files provided with relational links through file-level meta-information. Hence, the operator can easily access the files usable in the phase.
(5) In the information analysis method according to the foregoing (4), the third step includes generating the phase-level (312) meta-information by aggregating or combining file-level meta-information.

This configuration enables the work terminal 8 to acquire files usable in a phase with reference to the relational links in phase-level meta information provided by the information analysis and collection server 2.

It should be noted that this invention is not limited to the above-described embodiments but includes various modifications. For example, the above-described embodiments provide details for the sake of better understanding of this invention; they are not limited to those including all the configurations as described. A part of the configuration of an embodiment may be replaced with a configuration of another embodiment or a configuration of an embodiment may be incorporated into a configuration of another embodiment. A part of the configuration of an embodiment is applicable of addition, deletion, and replacement of a different configuration, alone or in combination.

The above-described configurations, functions, processing units, and processing means, for all or a part of them, may be implemented by hardware, for example, by designing an integrated circuit. The above-described configurations and functions may be implemented by software, which means that a processor interprets and executes programs for providing the functions. The information of programs, tables, and files to implement the functions may be stored in a storage device such as a memory, a hard disk drive, or a solid-state drive (SSD), or a storage medium such as an IC card, an SD card, or a DVD.

The drawings include control lines and information lines as considered necessary to explain the embodiments but do not include all control lines or information lines in the actual products. It can be considered that most of all components are interconnected.

1. An information analysis method for an information analysis server including a processor and a memory to analyze files used in a work terminal connected via a network, the information analysis method comprising:
a first step, in which the information analysis server acquires files used in a plurality of phases of a work by phase and records the files to phase document information in association with locations of the files and the phases;
a second step, in which the information analysis server analyzes words included in each file and determines a file similar in words to be a relevant file to provide a relational link; and
a third step, in which the information analysis server records files used in each phase, locations of the files, and relational links provided to the files to meta-information.

2. The information analysis method according to claim 1, wherein the second step includes calculating appearance frequencies of the words by file, calculating rates of match of predetermined high-ranked words in appearance frequency between files as similarities, and determining that two files are relevant to provide a relational link in a case where a similarity of the two files is higher than a predetermined first threshold value.

3. The information analysis method according to claim 2, wherein the second step includes determining that two files are relevant to provide a relational link as far as a similarity of the two files is higher than a predetermined second threshold value that is higher than the first threshold value even in a case where the two files are used in different phases.

4. The information analysis method according to claim 2, wherein the meta-information includes file-level meta-information holding the relational links, the locations of the files, and the appearance frequencies of words by file and phase-level meta-information holding the relational links, the locations of the files, and the appearance frequencies of words by phase.

5. The information analysis method according to claim 4, wherein the third step includes generating the phase-level meta-information by aggregating or combining file-level meta-information.

6. An information analysis server comprising:
a processor;
a memory;
a work recording unit configured to acquire files used by a work terminal by phase of a work and record the files to phase document information in association with locations of the files and phases of the work;
a document analysis unit configured to analyze words included in each file; and
a file relationship extraction unit configured to provide a relational link to a file similar in words as a relevant file,
wherein the work recording unit is configured to record files used in each phase, locations of the files, and relational links provided to the files to meta-information.

7. The information analysis server according to claim 6,
wherein the document analysis unit is configured to calculate appearance frequencies of the words by file, and
wherein the file relationship extraction unit is configured to calculate rates of match of predetermined high-ranked words in appearance frequency between files as similarities, and determine that two files are relevant to provide a relational link in a case where a similarity is higher than a predetermined first threshold value.

8. The information analysis server according to claim 7, wherein the file relationship extraction unit is configured to determine that two files are relevant to provide a relational link as far as a similarity of the two files is higher than a predetermined second threshold value that is higher than the first threshold value even in a case where the two files are used in different phases.

9. The information analysis server according to claim 7, wherein the meta-information includes file-level meta-information holding the relational links, the locations of the files, and the appearance frequencies of words by file and phase-level meta-information holding the relational links, the locations of the files, and the appearance frequencies of words by phase.

10. The information analysis server according to claim 9, wherein the work recording unit is configured to generate the phase-level meta-information by aggregating or combining file-level meta-information.

11. A digital information management system comprising:
a first computer configured to store files;
a second computer to use the files in a work;
an information analysis server configured to analyze the files used by the second computer; and
a network connecting the first computer, the second computer, and the information analysis server,
wherein the information analysis server includes:
a work recording unit configured to acquire files used by the second computer by phase of the work and record the files to phase document information in association with locations of the files and phases of the work;
a document analysis unit configured to analyze words included in each file; and
a file relationship extraction unit configured to provide a relational link to a file similar in words as a relevant file, and
wherein the work recording unit is configured to record files used in each phase, locations of the files, and relational links provided to the files to meta-information.
